(19) United States
(12) Patent Application Publication
(10) Pub. No.: US 2026/0102948 A1
(43) Pub. Date: Apr. 16, 2026

(54) METHOD FOR CLEANING PLASTIC WASTE

(71) Applicant: HydroDyn Recycling GmbH, Hamburg (DE)

(72) Inventors: Michael Hofmann, Hamburg (DE); Alexander Gercke, Bad Oldesloe (DE); KSiStof Uckuronis, Salos (LT)

(73) Assignee: HydroDyn Recycling GmbH, Hamburg (DE)

(21) Appl. No.: 19/113,065

(22) PCT Filed: Aug. 16, 2023
(86) PCT No.: PCT/EP2023/072527

§ 371 Date: Mar. 19, 2025

(30) Foreign Application Priority Data
Sep. 22, 2022 (DE) 10 2022 124 404.0

(51) Int. Cl. B29B 17/02; B29B 17/00; B29B 17/04

(52) U.S. Cl. CPC B29B 17/02; B29B 17/04; B29B 2017/001; B29B 2017/0217; B29B 2017/0289; B29B 2017/0448

(57) ABSTRACT

A method for cleaning pre-comminuted plastic waste includes pretreating pre-comminuted plastic waste using a pretreatment apparatus. The pretreating includes at least one of (i) heating the pre-comminuted plastic waste with a heating apparatus of the pre-treatment apparatus to a cleaning temperature, and (ii) adding at least one cleaning additive and mixing the plastic waste with the at least one cleaning additive by the pretreatment apparatus. The pre-comminuted, pretreated plastic waste output from the pretreatment apparatus is cleaned in a cleaning apparatus. The cleaning includes directing the pre-comminuted, pretreated plastic waste together with a cleaning liquid through a working gap defined between mutually facing working surfaces of two cleaning tools that each include a plurality of cleaning teeth. The two cleaning tools are rotatably driven relative to each other to remove impurities from the pre-comminuted plastic waste. The cleaned, pre-comminuted plastic waste is then dried by a drying apparatus.

### CROSS-REFERENCE TO RELATED APPLICATIONS

This is a U.S. National Application of PCT/EP2023/072527, filed on Aug. 16, 2023, and claiming the priority and benefit, under relevant portions of 35 U.S.C. § 119, of German Patent Application No. 10 2022 124 404.0, filed on Sep. 22, 2022. The entire contents of said applications are hereby incorporated by reference.

### TECHNOLOGICAL FIELD

The following disclosure is directed to embodiments of a method for cleaning pre-comminuted plastic waste, in particular plastic flakes.

### BACKGROUND

Traditional washing technologies with cold or hot process water, for example, are used for the cleaning. A method of this kind for cleaning with multiple cleaning tanks through which the product to be cleaned passes, with the addition of cleaning agents which are intended, in particular, to separate ink from the plastic waste, is known, for example, from EP 2 832 459 B1. However, hot-melt adhesives, printing inks, and metallizations are not completely removed in the process. Complete removal should be understood to mean residual contaminations of less than 10 ppm that gives rise to only minor so-called VOCs (volatile organic components) during thermal further processing, for example extrusion or melting. In traditional caustic soda hot washes, printing inks, for example, are only removed if surfactants that are specially adapted to the caustic soda are used and if the flakes are penetrated for long periods of time in the washing lye. The removal of hot-melt adhesives is also problematic. The adhered residues in the range of at least less than 100 ppm required by the market are not generally achieved in the process. This is noticeable in the application of the recycled materials, namely due to gels in the film or a yellow tinge. Another serious consequence is outgassing during granular extrusion or during further processing in LSP (liquid state polymerization), which condenses PET in a high vacuum.

The consequences of inadequate purification that is merely “clean” as opposed to “high-purity” severely restrict the application of recycled materials and thus the marketing thereof. At the same time, requirements on the quality of the polymers are becoming stricter and are, namely, comparable with those of primary plastics. Products made of recycled materials must largely be free from adhering printing inks, various VOCs which hamper the degassing and melt filtration in the extruder, and extrinsic contaminations, since such remaining impurities can lead to adverse changes in the polymer properties in terms of the mechanics and the processing as well as to undesired changes in the color and odor. The contaminants described above would make it impossible to obtain approval for the recycled materials to be used as packaging for foodstuffs if they are not removed during the cleaning process.

EP 2 094 462 B1 discloses a method for separating celluloses and other adhering substances during recycling from waste plastic, in particular mixed plastic, in which films and pieces of thicker plastic parts of potentially pre-sorted plastic waste are mechanically pre-comminuted into flakes or particles of up to a specified size and the comminuted material is introduced into a disc refiner together with water without previously generating compacted material or else an agglomerate from the flakes. Impurities are largely abraded from the flakes by the cooperating discs of the disc refiner and are subsequently present as separate substances which can be separated from the plastic parts by means of a suitable separation method. EP 2 094 461 B1 discloses a similar method.

EP 2 734 302 B1 discloses another method for removing impurities on plastic shreds using a disc refiner. The disc refiner is not a toothed disc refiner, but rather comprises, on each of the cleaning surfaces of the cleaning discs, a plurality of cleaning ribs that extend between an inner and outer edge of the cleaning surfaces, wherein multiple cleaning webs that run transversely to the extension direction of the cleaning ribs are arranged between at least some mutually adjacent cleaning ribs. At least one flank of the cleaning ribs is inclined or curved with respect to the axial direction of the relevant cleaning disc, and the cleaning webs each rise in a ramp-like manner and have a lower height than the cleaning ribs. In this way, low mechanical stress on the plastic shreds is achieved during cleaning by drawing same between the discs, in particular between the cleaning ribs, and by preventing creasing or else folding or balling of the plastic shreds, which can result in insufficient cleaning.

EP 3 057 751 B1 further discloses a device and a method for cleaning plastic, in particular plastic shreds, in the course of plastic recycling. A toothed disc refiner is used which has a central inlet for feeding the plastic to be cleaned into the working gap and which has an outlet provided on the outer edge of the working gap for the cleaned plastic together with abraded impurities and water. The outlet comprises an outlet pipe through which water is pumped that flows past to the side of the working gap during operation, that is directed tangentially to the working gap, and that has a suction effect on the working gap, such that the cleaned plastic is conveyed into the outlet pipe. In this way, the discharge consistency can be flexibly set in addition to the feed and cleaning consistency, in particular regardless of the cleaning consistency. This makes it possible, in the interests of maximum energy efficiency and a maximum cleaning effect, to set a high solids consistency in the working gap and, at the same time, to set a subsequent suspension for the working gap that can be conveyed or else pumped well and that is of a low solids consistency.

Proceeding from the explained prior art, the object of the invention is therefore to provide a method of the type mentioned at the outset by means of which plastic waste can be cleaned of a wide variety of impurities to the greatest extent possible.

### BRIEF SUMMARY OF THE INVENTION

Aspects of the following disclosure are directed to aspects of a method of cleaning plastic waste including preforming a pre-treatment step in which pre-comminuted plastic waste is pre-treated in a pre-treatment apparatus. In some embodiments, the pre-treatment comprises heating the plastic waste with a heating apparatus of the pre-treatment apparatus to a cleaning temperature and/or adding at least one cleaning additive and mixing the plastic waste with the at least one cleaning additive by means of the pre-treatment apparatus. In some embodiments, the method includes performing a cleaning step in which the plastic waste pre-treated in the pre-treatment apparatus is cleaned in a cleaning apparatus. In some embodiments, the cleaning apparatus comprises two cleaning tools driven in rotation relative to each other, wherein the plastic waste together with a cleaning liquid is directed through a working gap between mutually facing working surfaces of the cleaning tools having cleaning teeth, wherein impurities are removed from the plastic waste by friction. In some embodiments of the method a drying step is performed in which the plastic waste cleaned in the cleaning apparatus is dried in a drying apparatus.

Some embodiments of the method according to the invention are used to clean pre-comminuted plastic waste, for example plastic flakes or else plastic shreds comminuted from plastic films. In principle, plastic flakes can be produced by means of comminution from thin-walled hard plastics or films, etc. The impurities to be removed may, in particular, be surface adhesions, such as cellulose from label residues, hot-melt adhesives, organic contaminants from food residues, printed layers of ink, possibly with printed sealant, surface metallizations, adhesive labels made of paper, plastic films or metal foils, etc. In some embodiments, the method according to the invention is used to clean pre-comminuted plastic waste. The plastic waste can be provided already comminuted. However, it is also possible that the method according to the invention comprises comminuting the plastic waste before carrying out the cleaning process. The comminution of plastic waste mentioned in this application can be carried out, for example, by mechanical comminution apparatuses such as shredders or granulators.

In some embodiments, in the pre-treatment step, the pre-comminuted plastic waste is pre-treated in a pre-treatment apparatus for optimum subsequent cleaning. Therefore, in particular, the plastic waste is not yet cleaned in the pre-treatment step. In particular, the pre-treatment step preferably comprises substantially no friction and substantially no or only slight agitation of the plastic waste. The pre-treatment comprises heating the plastic waste with a heating apparatus of the pre-treatment apparatus to a cleaning temperature and/or adding at least one cleaning additive and mixing the plastic waste with the at least one cleaning additive by means of the pre-treatment device. A liquid, such as water, can also be added during the pre-treatment step. In particular, this may already be the cleaning liquid used in the cleaning step. The pre-treatment serves to act on the surfaces of the plastic waste, for example using a temperature-controlled washing lye at a defined temperature and with a defined contact time. As mentioned, substantially no friction is exerted on the surfaces of the plastic waste during pre-treatment, for example via agitation. The task of the pre-treatment apparatus is rather to soften the structure of an impurity adhering to the surfaces of the plastic waste, such as a printed layer or an adhesive layer, and to override the Van der Waals forces. The purpose of the pre-treatment is therefore to reduce the physical binding forces that cause the impurities to adhere to the plastic surface. Detachment of the impurities, for example printing inks, substantially does not take place during the pre-treatment step and is also undesirable in order to avoid the migration of impurities into the interfaces of the plastics. The pre-treatment apparatus may have thermal insulation to keep the plastic waste heated by the heating apparatus at the specified cleaning temperature for a specified time. After the pre-treatment, the plastic waste is optimally prepared for subsequent cleaning.

In some embodiments, the method according to the invention further comprises a cleaning step in which the pre-treated plastic waste is cleaned in a cleaning apparatus. In particular, the cleaning apparatus forms a toothed disc cleaner and comprises two mutually facing cleaning tools, which may be cleaning discs, for example. At least one of the cleaning tools is driven in rotation by a rotary drive, such that relative rotation takes place between the cleaning tools. In some embodiments, the cleaning tools each have a working surface provided with cleaning teeth. The working surfaces are annular, in particular in the shape of a circular ring, wherein an annular, in particular circular working gap is delimited between the mutually opposing working surfaces. The cleaning teeth of the opposing working surfaces mesh together such that the cleaning tools form a positive tool and a negative tool. The teeth on the working surfaces are, in particular, individual teeth which are thus not interconnected by means of ribs or the like. It is possible to axially adjust the cleaning tools relative to each other by means of a corresponding adjusting apparatus, as a result of which the width of the working gap can be set. In this way, depending on the plastic waste to be cleaned, a desired friction can be achieved by the cleaning teeth meshing with each other, such that the impurities can be optimally removed from the correspondingly pre-treated plastic waste. The plastic waste is cleaned by friction. In particular, impurities are abraded from the surfaces of the plastic waste. For this purpose, it is possible to set a very small distance between the cleaning teeth of the opposing cleaning tools by means of a corresponding axial adjustment until they come into contact with each other. For example, it is possible for the cleaning teeth to come into contact with the base of the opposite cleaning tool. A small gap can be left between the tooth flanks of the cleaning teeth, such that the plastic waste is forced over the tooth flanks in order to achieve an optimum cleaning result. The axis of rotation of the at least one rotatably driven cleaning tool, in particular of the cleaning disc, may simultaneously be the axis of symmetry of the cleaning tool, in particular of the cleaning disc. An electric drive, for example, may be used as the rotary drive.

In some embodiments, the cleaning apparatus comprises an inlet that may, for example, open centrally into the working gap. The plastic waste to be cleaned is directed into the working gap via said inlet, for example together with the cleaning liquid. However, it is also possible to feed the cleaning liquid and the plastic waste separately into the working gap. The plastic waste to be cleaned is directed through the working gap together with the cleaning liquid, which is introduced separately or together with the plastic waste. In some embodiments, the cleaning liquid may, in particular, be water. This also applies to the other exemplary embodiments mentioned below. The plastic waste is sheared between the cleaning tools and is thus distributed evenly in the working gap. The plastic waste passes through the rows of numbers formed by the cleaning teeth. In the course of the friction exerted by the cleaning teeth on the plastic waste, impurities are abraded or else removed from the surfaces. The plastic waste is discharged from the working gap of the cleaning apparatus for further processing together with the detached adhesions or else impurities and the cleaning liquid via an outlet. In combination with the previous pre-treatment, the cleaning step can reliably and extensively remove practically any impurities from the plastic waste.

In some embodiments, the cleaning step can be followed by, for example, mechanical liquid separation, i.e. separation of the plastic waste from the cleaning liquid. In particular, the liquid can be separated immediately, for example within less than one minute, preferably less than 30 seconds, after it has exited the outlet of the cleaning apparatus. This reliably prevents re-contamination due to the cleaned plastic dwelling for too long. Insofar as liquid separation is provided for in this application, this can be carried out using a phase separator and/or a centrifuge, for example.

In some embodiments, the cleaning step is followed by a drying step in which the plastic waste cleaned in the cleaning apparatus and, if necessary, separated from the cleaning liquid and thus the separated impurities, is dried in a drying apparatus. Drying brings the cleaned plastic waste into a condition that can be processed further without any problems. After drying, the plastic may, for example, have a residual moisture content of less than 5%, preferably less than 3%. After the drying step, a classification step, for example an air classification step, may take place in which three-dimensional plastic flakes are separated from thin film flakes. This facilitates further processing.

In some embodiments, by means of the method according to the invention, a purity of the purified plastic waste of less than 100 ppm residual contamination, preferably less than 50 ppm, and even more preferably less than 20 ppm, can be achieved. This is achieved by combining the pre-treatment step with appropriate temperature control and/or the effect of cleaning additives, but in particular without exerting friction on the plastic waste, with subsequent cleaning by friction in an appropriate cleaning tool. In this way, a precise contact time in combination with a defined temperature and/or a defined cleaning additive can be realized in the pre-treatment step without impurities already being removed from the plastic waste, in particular the plastic flakes. In methods according to the prior art, such as those described in EP 2 832 459 B1, the plastic waste is cleaned in agitation containers in which the temperature is controlled and cleaning additives are added. This does not allow for defined cleaning, since it is not ensured that the substantially random agitation of the plastic waste in the agitation containers, for example by means of stirring, exposes all plastic particles to a cleaning effect in the same way. The result is incomplete cleaning of individual plastic particles. In the prior art, this problem is addressed by working with higher cleaning temperatures and larger quantities of cleaning additives as well as longer contact times. However, this is undesirable from an energy and environmental point of view.

In some embodiments, however, the pre-treatment step is not used to clean the plastic waste, but merely for a defined pre-treatment for the subsequent friction cleaning in the cleaning apparatus. The use of energy, the dwell time, and the need for cleaning additives can be optimized, with correspondingly advantageous effects on operating costs and environmental compatibility. Thanks to its cleaning tooth geometry, the cleaning apparatus ensures that all plastic particles are substantially subjected to the same cleaning friction. This means that the cleaning result is consistently optimal for all plastic particles. The pre-treatment step, which is only used for pre-treatment, prevents the premature removal of impurities, such as printing inks or coatings, into the liquid used in the pre-treatment step, which would impair the effectiveness and re-use of cleaning additives. Intensive preparation of the liquid used in the pre-treatment step can be avoided.

The solids consistency of the suspension of plastic waste and cleaning liquid in the cleaning step is also important. For optimum cleaning, the solids content of the plastic waste to be cleaned in the working gap in relation to the cleaning liquid in the working gap should be less than 5 wt. % for plastic waste in the form of films and less than 10 wt. % for plastic waste in the form of PET or else hard plastics.

In some embodiments, the pre-treatment apparatus may comprise multiple pre-treatment containers which receive the plastic waste during the pre-treatment. In this way, the desired temperature control and/or the desired contact time of any cleaning additives can be set in a defined manner. The batch-wise pre-treatment of the plastic waste in multiple pre-treatment containers makes it easy to ensure the desired minimum dwell time for controlling the temperature of or else for the action of cleaning additives, unlike with a continuous product flow. The plastic waste to be cleaned can be fed from the pre-treatment containers for further processing one after the other and after the specified dwell time in each case.

In some embodiments, the pre-treatment apparatus may comprise at least one pre-treatment screw which conveys the plastic waste during the pre-treatment step. The pre-treatment screw conveys the plastic waste, in particular together with a liquid, for example the cleaning liquid used in the subsequent cleaning step. The pre-treatment screw may be completely filled with the liquid. The pre-treatment screw may be used to set a defined dwell time for the plastic waste. The pre-treatment screw may comprise the heating apparatus and/or thermal insulation. The pre-treatment screw may also comprise at least one feed apparatus for the at least one cleaning additive. However, it is also possible that the at least one cleaning additive is added to the plastic waste before it enters the pre-treatment screw and/or that the plastic waste is heated before it enters the pre-treatment screw.

According to some embodiments, the pre-treatment apparatus may comprise at least one pre-treatment pipe system, in particular a pipe bundle system, through which the plastic waste is conveyed during the pre-treatment step. The plastic waste is also conveyed through the pre-treatment pipe system, for example by means of a pump together with a liquid, such as the cleaning liquid used in the subsequent cleaning step. The pre-treatment pipe system may be completely filled with the liquid. The pre-treatment pipe system may also be used to set a defined dwell time for the plastic waste. The pre-treatment pipe system may comprise the heating apparatus and/or thermal insulation. The pre-treatment pipe system may also comprise at least one feed apparatus for the at least one cleaning additive. However, it is also possible that the at least one cleaning additive is added to the plastic waste before it enters the pre-treatment pipe system and/or that the plastic waste is heated before it enters the pre-treatment pipe system.

In some embodiments, the pre-treatment apparatus may also comprise a stirring container in which the plastic waste is stirred into a suspension. As a result, the action of cleaning additives and, if applicable, the temperature control is achieved particularly reliably and uniformly. Furthermore, it is possible that the stirring container or one of the pre-treatment containers or more than one of the pre-treatment containers comprises a heating apparatus and/or thermal insulation. It is also possible that the stirring container or one of the pre-treatment containers or more than one of the pre-treatment containers comprises feed apparatuses via which the at least one cleaning additive is fed directly into the pre-treatment container(s).

According to some embodiments, the cleaning temperature may be at least 40° C. and no more than 90° C., preferably no more than 70° C., further preferably no more than 60° C. It has been shown that, in the method according to the invention, the desired cleaning effect is already achieved at significantly lower cleaning temperatures compared to the prior art and, if applicable, also a significantly reduced use of cleaning additives and significantly reduced dwell times. Some plastics, such as amorphous PET, crystallize even at relatively low temperatures in the range of from 70° C. to 80° C. and become correspondingly brittle. The use of brittle recycled materials is usually not possible or severely restricted. Since cleaning is already possible at lower cleaning temperatures of less than 70°, preferably no more than 60° C., crystallization of even problematic plastics can be reliably avoided. Reduced use of cleaning additives is also desirable from an environmental point of view.

In some embodiments, the at least one cleaning additive may comprise at least one surfactant and/or at least one caustic soda and/or at least one complexing agent. The desired pre-treatment is particularly effective with such cleaning additives.

In some embodiments, the cleaning tools of the cleaning apparatus may be cleaning discs. The plastic waste can be introduced into the working gap through an inlet opening centrally into the working gap and led out of the working gap through an outlet provided at the outer edge of the working gap. In particular, the inlet may open into the working gap in the axial direction of the cleaning discs.

In some embodiments, the width of the working gap in a first section may narrow outwards in a radial direction starting from the inlet and the width of the working gap in a second section arranged radially outside the first section may be constant. The first section and the second section may, in particular, be a first annular section and a second annular section. The inflow zone formed by the first section is used to receive the material quantity of plastic waste at the inlet. On account of the initially wider and then outwardly narrowing working gap in the first section, homogenization and uniform distribution of the plastic waste occurs, even if the feed consistency, i.e. the content of plastic waste, fluctuates significantly per unit of time and/or by volume of process liquid. This homogenization and uniform distribution is crucial for the subsequent cleaning success. Optimal cleaning can only be achieved if the plastic waste is transported as uniformly and separated as possible along the rows of teeth formed by the opposing cleaning teeth outward to the outlet.

The second section, in which the working gap width is constant, is also crucially important here. Only the combination of the narrowing first section and the constant second section yields the optimal cleaning result, in that the required homogenization and equalization of the plastic waste takes place in the first section and sufficient physical loading of the plastic waste for an optimal cleaning effect is achieved in the second section with an unchanging working gap width. Thus the plastic waste, in particular the plastic flakes, becomes oriented in parallel with the flanks of the cleaning teeth in the inflow zone formed by the first section, wherein accumulation or clumping of plastic waste, which would be prejudicial to the cleaning, is prevented. In the working zone formed by the second section, the required processing of the plastic waste for the cleaning takes place.

In particular, plastic flakes created from plastic films are difficult to dose for cleaning, since they have a high dry and wet volume at a low bulk density. On account of the design of the working gap with the first section and the inflow zone formed thereby, the cleaning tools can also receive, for example, sinusoidally fluctuating doses without a problem, for example without becoming clogged. On account of the design of the working gap, sandwiched or film packets created in the course of the comminution of plastic films are also reliably disintegrated.

In some embodiments, for optimum cleaning, it is crucial that the entire surface of plastic waste produced from films by pre-comminution, in particular, is guided over the cleaning teeth such that the surfaces are completely cleaned. The pre-comminution of the plastic waste is of particular importance insofar as the pre-comminuted plastic waste can be lengthened on account of the unfolding, by the cleaning tools according to the invention, of plastic flakes that are folded together in a concertina-like manner as well as on account of the disintegration of film packets into individual flakes. In practice, for example, an average particle size of the pre-comminuted plastic waste of no more than 50 mm, preferably no more than 25 mm, for example in the range of from 20 to 25 mm, has proven to be expedient. This makes it possible to achieve complete friction of the entire surfaces of the plastic waste in the working zone formed by the second section with practical dimensions of the cleaning teeth. The friction exerted by the opposing cleaning teeth achieves complete removal of impurities such as printing inks that are particularly difficult to clean or metallized surfaces. This makes it possible to achieve a cleaning result with extrinsic residual contaminations of less than 100 ppm, preferably less than 10 ppm. This means that the recycled materials produced according to the invention can be used as primary plastics for the production of plastic parts.

In some embodiments, the cleaning apparatus may further comprise a means for axially adjusting the cleaning tools relative to each other, such that the width of the working gap can be adjusted, wherein the cleaning teeth of the cleaning tools can be brought into contact with each other in the second section. This configuration allows for sufficient friction to be achieved by the cleaning tools or rather cleaning teeth for cleaning even thin film waste. The cleaning teeth of the opposing cleaning tools may engage with each other in a form-fitting manner, in particular.

In some embodiments, the second section may follow on directly from the first section. In this way, the transition between the inflow zone formed by the first section and the working zone formed by the second section is optimized. In some embodiments, the second section may extend to the outer edge of the working gap. The first section and the second section together may cover the entire working gap. However, it is also conceivable, for example, for an inlet portion on which, for example, no cleaning teeth are arranged to be provided between the inlet and the first section.

In some embodiments, the working surfaces of the cleaning tools comprising the cleaning teeth may be arranged in a cone shape in the first section and in parallel with each other in the second section. In this way, the first and second section can be designed in a particularly simple manner.

In some embodiments, the cleaning teeth may be arranged on the surface sections of the working surfaces of the cleaning tools that form the first section in each case at a greater distance from each other than on the surface sections of the working surfaces of the cleaning tools that form the second section. The density of cleaning teeth per unit of area is thus lower in the first section than in the second section. As a result, the inflow of the plastic waste is further facilitated and the homogenization and equalization as well as separation of the plastic waste is further improved, while particularly effective cleaning takes place in the working zone formed by the second section on account of the cleaning teeth arranged closer together.

In some embodiments, the cleaning tool may, in principle, be configured as described in the parallel German patent application 10 2022 117 372.0 by the present applicant, which has not been published previously. In some embodiments, the cleaned plastic waste may be dried in the drying apparatus by means of pressing and/or air drying. This achieves particularly effective drying.

In some embodiments, it can be provided that a pre-cleaning step is carried out before the pre-treatment step, in which the comminuted plastic waste is cleaned in a pre-cleaning apparatus, wherein the pre-cleaning apparatus comprises two cleaning tools driven in rotation relative to each other, wherein the plastic waste together with a cleaning liquid is directed through a working gap between mutually facing working surfaces of the cleaning tools having cleaning teeth, wherein impurities are removed from the plastic waste substantially without friction.

In some embodiments, the cleaning liquid may again be water. Pre-cleaning of the plastic waste pre-treated in the pre-treatment apparatus can be advantageous depending on the type of plastic waste to be cleaned, among other things. In the case of plastic waste, a basic distinction is made between plastic waste from the consumer sector, known as post-consumer raws (PCR), and plastic waste from the industrial sector, known as post-industrial raws (PIR). PCRs, in turn, are distinguished according to their origin, namely whether they come from the domestic, agricultural, or retail sector. PCR raw materials have very different levels of contamination with impurities. As a rule, these are significantly higher than 50,000 ppm. The contaminations are also diverse, but are especially cellulose from adhesive labels, food residues, adhesives, mineral deposits of soil and clay, but also printing inks. PIR raw materials generally have an average contamination level of 50,000 ppm. The contaminations are more limited and include almost exclusively printing inks, primers, binders, and sealants. The pre-cleaning step is particularly important for the desired cleaning result with PCR plastic waste. In the case of PIR plastic waste, the pre-cleaning step can further improve the cleaning result, but it is not absolutely necessary. Pre-cleaning in the pre-cleaning step is carried out, in particular, without cleaning additives. Pre-cleaning may also be carried out without temperature control, in particular with unheated cleaning liquid. The solids consistency should be similar to that in the cleaning step. Pre-cleaning allows for further improved subsequent cleaning in the cleaning step by significantly reducing contaminations. Pre-cleaning is also used to split up flake packets. The pre-cleaning tool may, in principle, be configured similar to the cleaning tool, but substantially no friction is exerted on the surfaces of the plastic waste during the pre-cleaning. In particular, the distance between the cleaning teeth of the pre-cleaning tool can be selected to be greater than for the cleaning tool in the cleaning step. The focus is on the formation of a suspension of the plastic waste and the detached contaminants, such as paper labels, to form isolated cellulose fibers. Accordingly, there is a gap between the meshing cleaning teeth of the pre-cleaning tool. The pre-cleaning tool may be configured, in particular, as described in the parallel German patent application 10 2022 117 371.2 by the present applicant, which has not been published previously. After the pre-cleaning step, liquid separation may be carried out again, as already explained above for the cleaning step.

In some embodiment, after the pre-cleaning step and before the cleaning step, the pre-cleaned plastic waste may be further comminuted in a comminution step. The further comminution in the comminution step may take place before the pre-treatment step. As explained above, the particle size of the plastic flakes for cleaning in the cleaning step should be no more than 50 mm, preferably no more than 25 mm. This allows for complete removal of extrinsic contaminations. With larger plastic flakes, there is a risk that the entire surface will not be exposed to the cleaning friction, for example in the case of folded plastic flakes. In principle, the desired particle size is determined by the height of the cleaning teeth of the cleaning tool. To avoid excessive fines, which could lead to yield losses in subsequent steps, for example, the flake size should not be less than 5 mm. In the course of the pre-cleaning, plastic fragments lying next to each other may also unfold, such that longer plastic strips are present after the pre-cleaning, which are difficult to clean in the subsequent cleaning apparatus. For example, such long plastic strips are comminuted in the comminution step to a size that is suitable for the subsequent main cleaning. As explained, the comminution may take place in a mechanical comminution apparatus such as a shredder or granulator, for example.

In some embodiments, the plastic waste may be rinsed with a rinsing liquid after the pre-cleaning step and before the cleaning step. Rinsing may again be carried out before the pre-treatment cut. The rinsing liquid may, in particular, be water. Rinsing may be carried out in full flow. Rinsing may take place before or after the further comminution. Rinsing with rinsing liquid minimizes the transfer of already detached impurities caused by the pre-cleaned plastic waste to the subsequent steps.

In some embodiments, The cleaning liquid used in the pre-cleaning step may be conducted into a pre-cleaning liquid circuit. The cleaning liquid used in the cleaning step may also be conducted in a cleaning liquid circuit. The liquid consumption can be minimized by using such liquid circuits. This means that only a small amount of liquid from an external supply needs to be fed into the running process, namely to compensate for relatively small liquid losses caused by the cleaning liquid being transferred by the plastic waste to be cleaned. In practice, a fresh liquid consumption of less than 1 m³/ton of product to be cleaned is possible. A low liquid consumption reduces the operating costs and is desirable from an environmental point of view.

In some embodiments, the cleaning liquid used in the pre-cleaning step and/or the cleaning liquid used in the cleaning step may also be filtered. Such filter apparatuses, for example ultrafiltration apparatuses, can remove contaminants from the liquid circulating in a circuit, preventing recontamination by the liquid circuit and thus ensuring a lasting cleaning effect.

According to some embodiments, the pre-cleaning liquid circuit may be separated from the cleaning liquid circuit. This separation of the “dirty” pre-cleaning liquid circuit from the “clean” cleaning liquid circuit in the sense of a “firewall” can minimize contamination between the liquid circuits and thus recontamination of the, for example, already pre-cleaned plastic waste in the cleaning step. Due to the reliable separation between the liquid circuits, no cleaning liquid—apart from any cleaning liquid adhering to the plastic waste—and thus in particular not the impurities it contains that were removed during pre-cleaning, is passed on from the pre-cleaning process. If further comminution is carried out with cleaning liquid, this can also be done with the pre-cleaning liquid circuit or in a separate comminution liquid circuit. This, in turn, is then separated from the cleaning liquid circuit.

According to some embodiments, it can be provided that, after the cleaning step and before the drying step, a post-cleaning step is carried out in which the plastic cleaned in the cleaning apparatus is post-cleaned in a post-cleaning apparatus without the addition of cleaning additives, wherein the post-cleaning apparatus comprises two cleaning tools driven in rotation relative to each other, wherein the plastic waste is directed together with a cleaning liquid through a working gap between mutually facing working surfaces of the cleaning tools having cleaning teeth, wherein any cleaning additives remaining after the cleaning step are removed from the plastic waste.

In some embodiments, the cleaning liquid may again be water. In some embodiments, the post-cleaning apparatus may be configured in the same way as the pre-cleaning apparatus. Even in the course of post-cleaning, substantially no friction is exerted on the plastic waste that has already been cleaned in the cleaning step. The main purpose of post-cleaning is to remove any cleaning additives added in the pre-treatment step, in particular by hydrodynamic turbulence. Of course, further removal of impurities is also possible to a limited extent. Post-cleaning is carried out, in particular, without cleaning additives. Post-cleaning can also be carried out without temperature control, in particular with unheated cleaning liquid. After the post-cleaning step, liquid separation can be carried out again, as explained above.

In some embodiments, the cleaning liquid used in the post-cleaning step may, in turn, be into a post-cleaning liquid circuit. Again, the cleaning liquid used in the post-cleaning step may be filtered. In particular, ultrafiltration can be used to achieve an optimum post-cleaning result. The post-cleaning liquid circuit may, in turn, be separated from the cleaning liquid circuit in order to avoid corresponding contaminations between the cleaning steps.

### BRIEF DESCRIPTION OF THE DRAWINGS

An exemplary embodiment of the invention is explained below in greater detail based on figures.

Fig. 1a schematically illustrates and embodiment of a pre-cleaning step according to some embodiments of the disclosed method.

FIG. 1b schematically illustrates an embodiment of a comminution step according to some embodiments of the disclosed method.

FIG. 1c schematically illustrates an embodiment of pretreatment and cleaning steps according to some embodiments of the disclosed method.

FIG. 1d schematically illustrates an embodiment of a post-cleaning step according to some embodiments of the disclosed method.

FIG. 1e schematically illustrates an embodiment of a drying step according to some embodiments of the disclosed method.

If not otherwise specified, the same reference signs denote the same objects in the figures.

### DETAILED DESCRIPTION OF THE INVENTION

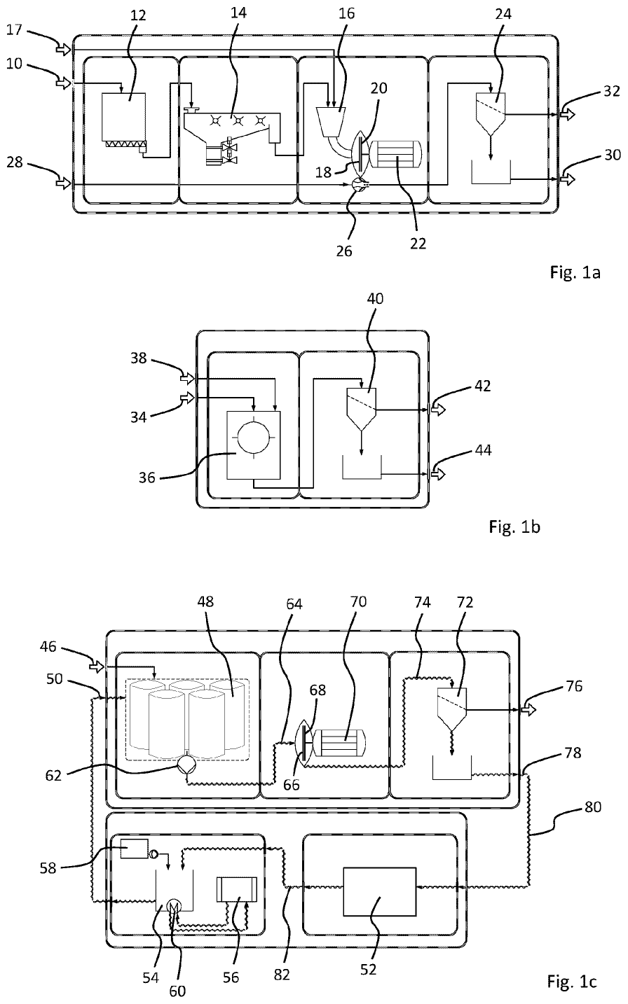

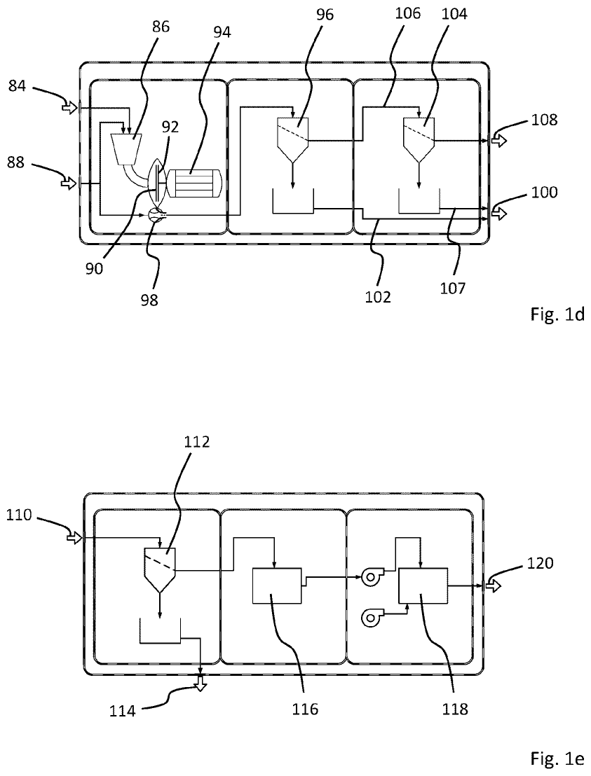

Figure 1a shows an embodiment of a pre-cleaning step of the method according to the invention. Pre-comminuted plastic waste to be cleaned, in particular in the form of plastic flakes, is fed to a storage silo 12 via a plastic inlet 10. The plastic waste to be cleaned passes from the storage silo 12 into a heavy material trap 14, in which any coarse heavy material contained in the plastic waste is separated from the plastic waste to be cleaned and discharged. From the heavy material trap 14, the plastic waste is fed into a feed hopper 16 of a pre-cleaning apparatus. A cleaning liquid, such as water, is also fed to the feed hopper 16 via a first liquid inlet 17. The plastic waste passes from the feed hopper 16 together with the cleaning liquid into a working gap formed between two cleaning discs 18, 20 of the pre-cleaning apparatus. In some embodiments, the pre-cleaning apparatus has an inlet that opens centrally into the working gap. For example, one of the cleaning discs 18, 20 is driven in rotation via a rotary drive 22. The cleaning discs 18, 20 have cleaning teeth on the surfaces thereof that delimit the working gap. The relative rotary movement between the cleaning discs 18, 20 conveys the plastic waste over the cleaning teeth and pre-cleans it in the process. The rotational movement causes the plastic waste to reach an outlet provided at the outer edge of the working gap, through which the plastic waste is fed to a mechanical liquid separator 24. In the example shown, a liquid pump 26 is also arranged in the region of the outlet, which liquid pump transports liquid supplied via a second liquid inlet 28, in particular water, tangentially past the working gap and the outlet thereof. The liquid pump 26 may also be in the form of a Venturi nozzle, wherein the liquid jet conveyed tangentially past the working gap and the outlet thereof exerts a suction effect on the working gap due to the Venturi effect, such that the plastic waste is conveyed out of the working gap and further on, as described in EP 3 057 751 B1. The liquid jet pumped by the liquid pump 26 or else the Venturi nozzle transports the mixture of pre-cleaned plastic waste and cleaning liquid exiting the outlet to the liquid separator 24. Mechanical liquid separation is used to separate the pre-cleaned plastic waste from the liquid. The separated liquid exits via the liquid outlet 30. Preferably, the discharged liquid is filtered and then fed back to the first and second liquid inlet 17, 28 in a circuit. The pre-cleaned plastic waste exits via an outlet 32 and reaches an inlet 34 of a comminution apparatus shown in FIG. 1b. The embodiment of the pre-cleaning apparatus shown in Figure la exerts substantially no friction on the plastic waste. The pre-cleaning apparatus may be configured as described in the parallel German patent application 10 2022 117 371.2 by the present applicant, which has not been published previously.

FIG. 1b illustrates an embodiment of a comminution step of an embodiment of the method according to the invention after the pre-cleaning step and before the subsequent cleaning step. For this purpose, the pre-cleaned plastic waste supplied via the inlet 34 arrives into a wet comminutor 36, to which liquid, such as water, is also fed via a liquid inlet 38. In the wet comminutor 36, the plastic waste is further mechanically comminuted to an optimum size for the subsequent cleaning step, as explained above. From the wet comminutor 36, the mixture of further comminuted plastic waste and liquid passes to a mechanical liquid separator 40, in which the further comminuted plastic waste is separated from the liquid. The further comminuted plastic waste exits via the outlet 42 and the separated liquid exits via the liquid outlet 44. The discharged liquid may, if necessary, be filtered and conducted back to the liquid inlet 38 in a circuit.

FIG. 1c illustrates the subsequent pre-treatment and cleaning steps. The pre-cleaned and further comminuted plastic waste passes from the outlet 42 (FIG. 1b) to an inlet 46 of a pre-treatment apparatus comprising multiple pre-treatment containers 48. A cleaning liquid, such as water, is also supplied to the pre-treatment containers 48 via a liquid inlet 50. The cleaning liquid is fed upstream of the liquid inlet 50 from a liquid preparation unit 52 to a mixing and heating container 54 of the pre-treatment apparatus. The cleaning liquid in the mixing and heating container 54 can be heated to a specified cleaning temperature by means of a heating apparatus 56, for example a superheated steam or gas heating apparatus, and a heat exchanger 60. Furthermore, at least one cleaning additive, for example at least one surfactant and/or at least one caustic soda and/or at least one complexing agent, can be added from a cleaning additive container 58 to the cleaning liquid located in the mixing and heating container 54. The mixture of cleaning liquid and, if applicable, the at least one cleaning additive, heated to the desired cleaning temperature depending on the process, is fed via the liquid inlet 50 to one of the pre-treatment containers 48 in each case, where it is mixed with the plastic waste fed in via the inlet 46. As soon as a pre-treatment container 48 is filled, the next pre-treatment container 48 is filled. As soon as the mixture of plastic waste and cleaning liquid and, if applicable, the at least one cleaning additive has reached a defined dwell time, the pre-treated mixture of plastic waste and cleaning liquid and, if applicable, the at least one cleaning additive is fed via a pump 62 to an inlet 64 of the cleaning apparatus. In this way, the pre-treatment containers 48 are filled and emptied one after the other.

As an alternative or in addition to the pre-treatment containers 48, the pre-treatment apparatus could also comprise a pre-treatment screw that conveys the mixture or a pre-treatment pipe system that conveys the mixture.

The basic configuration of the cleaning apparatus corresponds to the pre-cleaning apparatus described in FIG. 1a. In some embodiments, the cleaning apparatus also comprises two cleaning discs 66, 68, which delimit between them a working gap, in particular a working gap in the shape of a circular ring, to which the plastic waste is fed together with the cleaning liquid and the at least one cleaning additive via a central inlet. The cleaning discs 66, 68 in turn have cleaning teeth on the surfaces thereof that delimit the working gap, and at least one of the cleaning discs 66, 68 is driven in rotation by means of a rotary drive 70. As a result, the plastic waste is conveyed from the central inlet through the working gap and forced over the cleaning teeth of the cleaning discs 66, 68. The plastic waste is thus conveyed together with the cleaning liquid and the at least one cleaning additive to an outlet provided at the outer edge of the working gap and, from this outlet, to a further mechanical liquid separator 72, as illustrated in FIG. 1c by the arrow 74. The cleaning of the previously pre-cleaned, further comminuted plastic parts, which have undergone targeted and defined pre-treatment in the pre-treatment apparatus, takes place by friction through contact with the cleaning teeth of the cleaning discs 66, 68. In particular, the impurities remaining on the surface of the plastic waste are abraded by friction. Due to the pre-cleaning, further comminution, and pre-treatment of the plastic waste, the plastic waste is substantially completely cleaned. It has been shown that, in particular due to the pre-cleaning, further comminution, and pre-treatment according to the invention, as well as the use of the pre-cleaning apparatus and cleaning apparatus configured as toothed disc cleaners, it is possible to work with considerably lower cleaning temperatures compared to the prior art of less than 70° C., preferably less than 60° C., with optimum cleaning results. The use of cleaning additives was also reduced compared to the prior art. The cleaning apparatus may be configured as in the German patent application 10 2022 117 372.0 by the present applicant, which has not been published previously.

The liquid separator 72 in turn separates the cleaning liquid with the at least one cleaning additive and the impurities contained therein, which have been abraded from the plastic waste, from the cleaned plastic waste, which exits via the outlet 76. The separated cleaning liquid with the at least one cleaning additive and the abraded impurities exits via the liquid outlet 78 and is fed from here to the water preparation unit 52, as illustrated in FIG. 1c by the arrow 80. In the water preparation unit 52, the cleaning liquid is separated from the impurities and the at least one cleaning additive in the course of filtering, in particular ultrafiltration, such that the cleaned cleaning liquid can be fed back to the mixing and heating container 54 in a circuit, as illustrated in FIG. 1c by the arrow 82.

The cleaned plastic waste exiting the outlet 76 then passes to the inlet 84 of a post-cleaning apparatus shown in FIG. 1d. The plastic waste is fed from the inlet 84 into a feed hopper 86, to which a cleaning liquid, in particular water again, is also fed via a liquid inlet 88. The mixture of cleaned plastic waste and cleaning liquid is fed from the feed hopper 86 into a working gap, which may comprise the shape of a circular ring, formed between two cleaning discs 90, 92 of the post-cleaning apparatus, again in particular via a central inlet. At least one of the cleaning discs 90, 92 is driven in rotation by a rotary drive 94 and the cleaning discs in turn have cleaning teeth on the surfaces thereof that delimit the working gap. Due to the relative rotary movement between the cleaning discs 90, 92, the plastic waste fed in together with the cleaning liquid is subjected to post-cleaning, which in turn takes place substantially without friction. In particular, cleaning additives remaining on the cleaned plastic waste from the cleaning step are removed from the plastic waste. Via an outlet provided at the outer edge of the working gap, the post-cleaned plastic waste, together with the cleaning liquid and any separated cleaning additives, passes to a first mechanical liquid separator 96. The post-cleaning apparatus may be designed like the one shown in FIG. 1a. A liquid pump 98 is also located at the outlet of the post-cleaning apparatus, which also conveys cleaning liquid tangentially past the working gap and the outlet thereof via the liquid inlet 88 and thereby conveys the post-cleaned plastic waste together with the cleaning liquid containing the cleaning additives from the working gap to the first liquid separator 96. Again, the liquid pump 98 may also be in the form of a Venturi nozzle, wherein the liquid jet conveyed tangentially past the working gap and the outlet thereof exerts a suction effect on the working gap due to the Venturi effect, such that the plastic waste is conveyed out of the working gap and further on, as described in EP 3 057 751 B1. The liquid separated from the post-cleaned plastic waste in the first liquid separator 96 is discharged via a liquid outlet 100, as illustrated by the arrow 102 in FIG. 1d. The plastic waste dried in the first liquid separator 96 then passes to a second mechanical liquid separator 104, as illustrated by the arrow 106 in FIG. 1d. There, any remaining residual liquid is separated from the plastic waste and also discharged via the liquid outlet 100, as illustrated by the arrow 107 in FIG. 1d.

The further dried post-cleaned plastic waste exits via the outlet 108 and from there reaches an inlet 110 of the drying apparatus shown in FIG. 1e. The plastic waste is dried in the drying apparatus for subsequent re-use. Liquid discharged via the outlet 100 can in turn be conducted, if applicable filtered, back to the liquid inlet 88 in a circuit. The drying step according to FIG.1e initially comprises mechanical drying in a mechanical liquid separator 112. Liquid separated therein is discharged via a liquid outlet 114. Subsequently, the plastic waste passes through a thermal drying apparatus 116, where the plastic waste is dried to a residual moisture content of less than 5%, preferably less than 3%. Subsequent to the drying step, a classification, in particular air classification, can take place in a classification apparatus 118. Here, three-dimensional plastic flakes can be separated from thin film flakes. The finally cleaned and dried plastic waste exits via the outlet 120 and can be supplied for further processing.

### LIST OF REFERENCE SIGNS:

10 Plastic inlet
12 Storage silo
14 Heavy material trap
16 Feed hopper
17 First liquid inlet
18, 20 Cleaning disc
22 Rotary drive
24 Liquid separator
26 Liquid pump
28 Second liquid inlet
30 Liquid outlet
32 Outlet
34 Inlet
36 Wet comminutor
38 Liquid inlet
40 Liquid separator
42 Outlet
44 Liquid outlet
46 Inlet
48 Pre-treatment container
50 Liquid inlet
52 Liquid preparation unit
54 Mixing and heating container
56 Heating apparatus
58 Cleaning additive container
60 Heat exchanger
62 Pump
64 Inlet
66,68 Cleaning discs
70 Rotary drive
72 Liquid separator
74 Arrow
76 Outlet
78 Liquid outlet
80 Arrow
82 Arrow
84 Inlet
86 Feed hopper
88 Inlet
90, 92 Cleaning discs
94 Rotary drive
96 First liquid separator
98 Liquid pump
100 Liquid outlet
102 Arrow
104 Second liquid separator
106 Arrow
108 Outlet
110 Inlet
112 Liquid separator
114 Liquid outlet
116 Drying apparatus
118 Classification apparatus
120 Outlet

1-19. (canceled)

20. A method for cleaning pre-comminuted plastic waste, in particular plastic flakes, comprising:
pretreating pre-comminuted plastic waste using a pretreatment apparatus, wherein the pretreating comprises,
at least one of (i) heating the pre-comminuted plastic waste with a heating apparatus (56) of the pre-treatment apparatus to a cleaning temperature, and (ii) adding at least one cleaning additive and mixing the plastic waste with the at least one cleaning additive by the pretreatment apparatus,
cleaning pre-comminuted, pretreated plastic waste output from the pretreatment apparatus in a cleaning apparatus, wherein the cleaning comprises,
directing the pre-comminuted, pretreated plastic waste together with a cleaning liquid through a working gap defined between mutually facing working surfaces of two cleaning tools comprising a plurality of cleaning teeth, wherein the two cleaning tools are rotatably driven relative to each other and impurities are removed from the pre-comminuted, pretreated plastic waste by friction; and
drying pre-comminuted, cleaned plastic waste output from the cleaning apparatus, wherein the drying is done by a drying apparatus.

21. The method according to claim 20, further comprising structuring the pretreatment apparatus to include a plurality of pretreatment containers configured to receive the pre-comminuted plastic waste during the pretreating.

22. The method according to claim 20, further comprising structuring the pretreatment apparatus to comprise at least one pretreatment screw configured to convey the pre-comminuted plastic waste during the pretreating.

23. The method according to claim 20, further comprising structuring the pretreatment apparatus to comprise at least one pretreatment pipe system configured to convey the pre-comminuted plastic waste during the pretreating.

24. The method according to claim 20, further comprising structuring the pretreatment apparatus to comprise a stirring container, wherein the pre-comminuted plastic waste is stirred in in the stirring container.

25. The method according to claim 20, wherein the cleaning occurs at a cleaning temperature of at least 40° C. and not more than 90° C.

26. The method according to claim 20, further including comprising the at least one cleaning additive from at least one of: (i) a surfactant; (ii) at least one caustic soda; and (iii) at least one complexing agent.

27. The method according to claim 20, wherein the cleaning tools of the cleaning apparatus comprise cleaning discs, and further comprising,
introducing the pre-comminuted plastic waste centrally into the working gap through an inlet opening, centrally into the working gap; and
feeding the pre-comminuted plastic out of the working gap through an outlet positioned at an outer edge of the working gap.

28. The method according to claim 27, wherein a width of the working gap in a first section narrows outwards in a radial direction starting from the inlet and a width of the working gap in a second section arranged radially outside the first section is constant.

29. The method according to claim 20, further comprising drying the cleaned plastic waste by at least one of pressing and air drying.

30. The method according to claim 20, further comprising pre-cleaning the pre-comminuted plastic waste before the pretreating, wherein the pre-cleaning comprises cleaning the pre-comminuted plastic waste in a pre-cleaning apparatus, wherein:
the pre-cleaning apparatus comprises two cleaning tools driven in rotation relative to each other;
wherein pre-cleaned plastic waste together with a cleaning liquid is directed through a working gap between mutually facing working surfaces of the cleaning tools having cleaning teeth; and
wherein impurities are removed from the pre-comminuted plastic waste substantially without a friction force.

31. The method according to claim 30, further comprising comminuting a plastic waste, after the pre-cleaning and before the cleaning to form the pre-comminuted plastic waste.

32. The method according to claim 30, further comprising conducting at least one of:
(i) the cleaning liquid used in the pre-cleaning through a pre-cleaning liquid circuit; and (ii) conducting the cleaning liquid used in the cleaning through a cleaning liquid circuit.

33. The method according to claim 32, further comprising filtering at least one of: (i) the cleaning liquid used in the pre-cleaning; and (ii) the cleaning liquid used in the cleaning.

34. The method according to claim 32, wherein the pre-cleaning liquid circuit is separated from the cleaning liquid circuit.

35. The method according to claim 30, further comprising rinsing the pre-comminuted plastic waste with a rinsing liquid after the pre-cleaning and before the cleaning.

36. The method according to claim 20, further comprising:
post-cleaning the pre-comminuted plastic waste after the cleaning and before the drying, wherein the post-cleaning is carried out in a post-cleaning apparatus without cleaning additives;
structuring the post-cleaning apparatus to comprise two cleaning tools configured to be driven in rotation relative to each other;
directing the plastic waste together with a cleaning liquid through a working gap defined between mutually facing working surfaces of the two cleaning tools;
structuring the two cleaning tools to each comprise a plurality of cleaning teeth; and
removing any cleaning additives remaining on the plastic waste after the cleaning.

37. The method according to claim 36, further comprising conducting the cleaning liquid in the post-cleaning through a post-cleaning liquid circuit.

38. The method according to claim 37, further comprising filtering the cleaning liquid used in the post-cleaning.
